(19) United States
(12) Patent Application Publication
(10) Pub. No.: US 2025/0327686 A1
(43) Pub. Date: Oct. 23, 2025

(54) INCORPORATING UNCERTAIN SENSOR TIMESTAMPS IN A SLAM SYSTEM

(71) Applicant: Toyota Jidosha Kabushiki Kaisha, Toyota-Shi, Aichi-Ken (JP)

(72) Inventors: PAUL J. OZOG, Ann Arbor, MI (US); Mohamed Aladem, Ypsilanti, MI (US); Hai Jin, Fremont, CA (US); Yucong Lin, Ann Arbor, MI (US); Matthew Dreisbach, Ann Arbor, MI (US)

(21) Appl. No.: 18/642,677

(22) Filed: Apr. 22, 2024

(51) Int. Cl. G01C 21/00; G06T 7/73

(52) U.S. Cl. CPC G01C 21/3848; G01C 21/3807; G06T 7/74; G06T 2207/30252

(57) ABSTRACT

Systems and methods are provided that can improve a SLAM system to account for the inaccuracy in the timestamps of location data and image data that operate independently or with dedicated control units. For example, the systems and methods may replace the timestamps with a counter value that is communicatively coupled with the vehicle to generate an incremental progression of the data generated by the sensors. Additionally, the process may model data points (e.g., landmarks) in accordance with an uncertainty (e.g., covariance) that is shaped as an ellipsoid that represents the uncertainty in the position of the vehicle at a point based on the location sensor. As the speed of the vehicle increases, in one approach, the more elongated the ellipsoid becomes. The uncertainty in the time of the location data may be modeled as a covariance so that the location data can be modeled through the SLAM system.

### TECHNICAL FIELD

The present disclosure relates generally to improving the modeling of location data and image data at a vehicle that is used for autonomous and semi-autonomous operation of the vehicle, and in particular, some implementations may relate to aligning sensor data from self-contained sensors on a vehicle to implement a Simultaneous Localization and Mapping (SLAM) system at the vehicle that maps the environment surrounding the vehicle using the aligned sensor data to account for uncertainty/covariance of the location of landmarks in the environment while the vehicle is moving.

### DESCRIPTION OF RELATED ART

Imaging devices can generate digital image data of an environment to help create a digital representation of the environment. For example, a system may mount an imaging device to a vehicle in motion within the environment. Image data generated by the imaging device can be used to generate a map of the vehicle's surroundings and determine the vehicle's location within its environment.

In some instances, SLAM techniques may be applied to the image data to allow the vehicle to build a map of an unknown environment while simultaneously keeping track of its current location in the environment. In general, SLAM techniques may use data from different types of sensors (in addition to or in lieu of image data from cameras) to localize the mobile platform(s) and map the features of the environment. For example, other data from cameras and/or data from odometers, gyroscopes, and depth sensors may be used.

In some instances, traditional SLAM techniques may suffer from data association problems that can affect the accuracy of the resulting map. Data association refers to the process of determining whether two features observed at different points in time correspond to one object in the environment. When the SLAM system fails to properly associate data, the map can inaccurately display landmarks or other mapping features based on the errors caused by improper data association.

### BRIEF SUMMARY OF THE DISCLOSURE

According to various embodiments of the disclosed technology, vehicles, vehicle control systems, other systems, methods, and non-transitory computer readable media are described herein. For example, illustrative systems may comprise a vehicle in communication with a Simultaneous Localization and Mapping (SLAM) system. The vehicle may comprise various components, for example, a location sensor coupled with a location control unit to generate location data of the vehicle in an environment, an image sensor coupled with an image control unit to generate image data of the vehicle in the environment, a counter configured to incrementally generate counter values that couples the counter values with the location data and the image data, a memory, and a processor that us configured to execute machine readable instructions stored in the memory. The processor may append a first counter value from the counter to the location data that correlates timing of generation of the location data with generation of the counter value. The processor may also append a second counter value from the counter to the image data that correlates timing of generation of the image data with generation of the counter value. When the location data and the image data include a landmark, the processor may incrementally synchronize the location data with the image data using the first counter value and the second counter value, generate an ellipsoid of potential locations of the landmark adjacent to the vehicle, and generate a mapping of the vehicle in the environment that includes the ellipsoid of potential locations of the landmark.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example vehicle with which embodiments of the systems and methods disclosed herein may be implemented.

FIG. 2 illustrates an example architecture for location signal modeling using sensor data from self-contained sensors, in accordance with some embodiments of the systems and methods described herein.

FIG. 3 illustrates sensor data for identifying a landmark, in accordance with some embodiments of the systems and methods described herein.

FIG. 4 illustrates a probabilistic data association process that account for timestamp errors in the data, in accordance with some embodiments of the systems and methods described herein.

FIG. 5 shows examples of modeling the uncertainty in location covariance with respect to the speed of the vehicle, in accordance with some embodiments of the systems and methods described herein.

FIG. 6 illustrates a process for location signal modeling using sensor data from self-contained sensors, in accordance with some embodiments of the systems and methods described herein.

FIG. 7 is an example computing component that may be used to implement various features of embodiments described in the present disclosure.

The figures are not exhaustive and do not limit the present disclosure to the precise form disclosed.

### DETAILED DESCRIPTION

Vehicle sensors collect various information about the vehicle itself and surrounding environment, such as information about landmarks in the environment. The landmarks may include, for example, traffic lights, stop signs, road signs, sidewalks, buildings, and other static objects. Information about the landmarks can be captured by image sensors (e.g., camera), location/GNSS sensors, and the like. However, while the camera identifies landmarks ahead of the vehicle, the GNSS transceiver/sensor is usually located elsewhere on the vehicle. This can cause the timestamp associated with the GNSS location to differ from the timestamp associated with the camera/image when a landmark is determined.

Timestamps with sensor data are used in various vehicle processes, including with Simultaneous Localization and Mapping or “SLAM.” The SLAM technique is a process of mapping an area while keeping track of the location of the vehicle within that area. In some examples, the SLAM process can generate a map (e.g., offline or remotely at an external SLAM system) and the vehicle can use the map to perform localization, including for example, determining its current location and the location of landmarks. In some examples, the vehicle may also use the map to navigate to a new/second location. The vehicle can use the map generated from the SLAM process to digitize large areas around the vehicle so that the vehicle can autonomously determine its current location, or the location of a landmark adjacent to the vehicle, and navigate to a new location.

When the SLAM process associates the objects based on uncertain sensor timestamps, the resulting map may not be able to correlate the objects accurately. This is often referred to as the “data association problem,” since observed objects may not overlap in time.

Additionally, in many examples, both location determination and area mapping rely on image data and location data from different sensors. When these different sensors are “self-contained” (e.g., originate from a third party vendor or operate independently of a controller or other components of the vehicle), the sensors may generate image data and location data with timestamps from/associated with different clocks. That is, each self-contained sensor has its own control unit or processor, and data generated by each self-contained sensor will be associated with that sensor's own respective clock or timing. Because image data and location data are matched with the use of timestamps, if such timestamps do not share the same clock or if such timestamps are not normalized to the same timing, the image and location data cannot be accurately matched. This in turn, and in addition to the data association problem, can limit the use of such data for SLAM system mapping. The use of the data may be limited because, in some examples, the determination of the vehicle location or landmark location is inaccurate and fails to synchronize with each other across the data sources due to incongruent timestamps from different sensors.

Embodiments of the systems and methods disclosed herein can improve the SLAM system to account for the timestamps of location data and image data from/associated with different clocks that can cause the different sensors to have different reference time points. In some examples, the process may replace the timestamps with a counter value that is generated by a counter. The counter may be communicatively coupled with the sensors at the vehicle and the counter may be configured to generate an incremental timeline/progression of the sensor data and overcome any issues with mismatched reference points caused by the timestamps.

Additionally, the process may model data points (e.g., landmarks) in accordance with an uncertainty (e.g., covariance) based on a probability distribution of the sensor data points. For example, when a Gaussian distribution is implemented, the distribution of data points may be plotted as a bell-shaped curve, with the mean at the center and symmetric tails on both sides. The probability of the location of the landmark may be within the predicted distribution of data points. When the speed of the vehicle is incorporated with the distribution, the data points may be plotted as an ellipsoid, rather than a sphere, to account for a faster speed of the vehicle (x-axis) in relation to decreased changes in direction along the other axes of movement (y-axis or z-axis). The ellipsoid represents the uncertainty in the position of the landmark/vehicle. As the speed of the vehicle increases, in one approach, the more elongated the ellipsoid becomes.

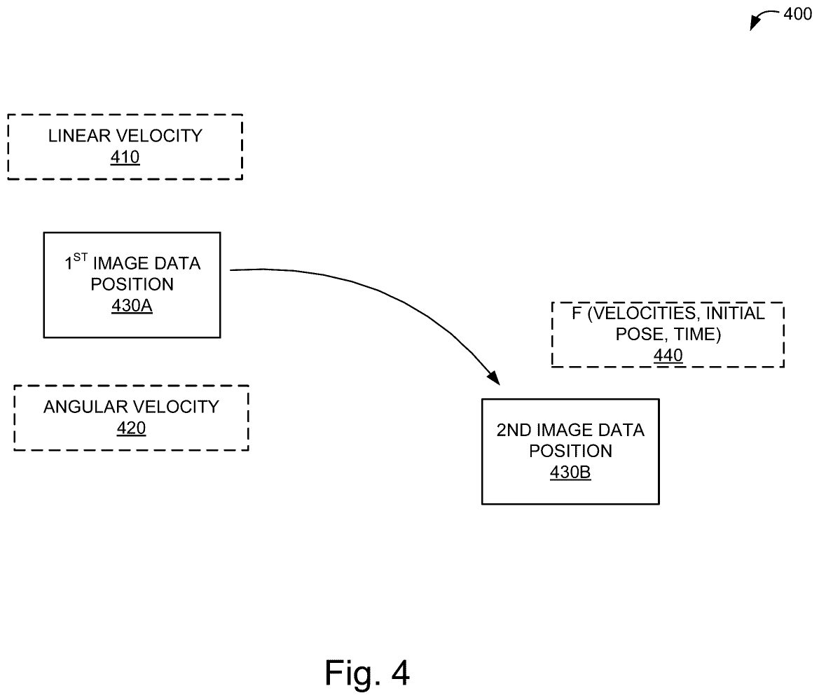

The uncertainty in the time of the location data may be modeled as a covariance so that the location data can be modeled through the SLAM system and help minimize the effects of the data association problem, for example, by implementing a probabilistic data association. For example, the ellipsoid models the uncertainty of GNSS signals, and the GNSS signals comprise translation errors due to an inaccurate association of timestamps in addition to GNSS positional errors. The process may calculate the translation error, for example, by multiplying a nominal speed value by a timestamp error value to help model the translation errors caused by the improperly associated timestamps. This can determine a probabilistic correlation to the data association that is traditionally attributed to the timestamp association. Additional description of the of the process for performing the probabilistic data association is described herein (e.g., at FIG. 4).

As an illustrative example, the vehicle may comprise a processor, memory, electric control unit, sensors, vehicle systems, and other components that are configured to operate the vehicle autonomously, semi-autonomously, or through manual operator interactions. The vehicle may also comprise a location sensor and an image sensor to help generate a digital mapping of the environment. The digital mapping can be used by the vehicle, autonomously, to help operate the vehicle within the environment. In some examples, the location sensor is coupled with a location control unit to generate location data of the vehicle in an environment, the image sensor is coupled with an image control unit to generate image data of the vehicle in the environment, and the vehicle also comprises a counter configured to incrementally generate counter values that couples the counter values with the location data and the image data. The processor of the vehicle may be configured to append a first counter value from the counter to the location data that correlates timing of generation of the location data with generation of the counter value and a second counter value from the counter to the image data that correlates timing of generation of the image data with generation of the counter value.

When the first counter value is appended to the location data and the second counter value is appended to the image data, the incrementally-generated counter values may help create a consistently-generated time series dataset with the sensor data. The timestamps that are originally generated with the sensor data may remain in the sensor data or may be removed. In some examples, the vehicle system may identify the counter values rather than the time stamps in generating the mapping of the environment.

When the location data and the image data include a landmark, the processor may incrementally synchronize the location data with the image data using the first counter and the second counter and generate an ellipsoid of potential locations of the landmark adjacent to the vehicle. The processor may generate a mapping of the vehicle in the environment that includes the ellipsoid of potential locations of the landmark.

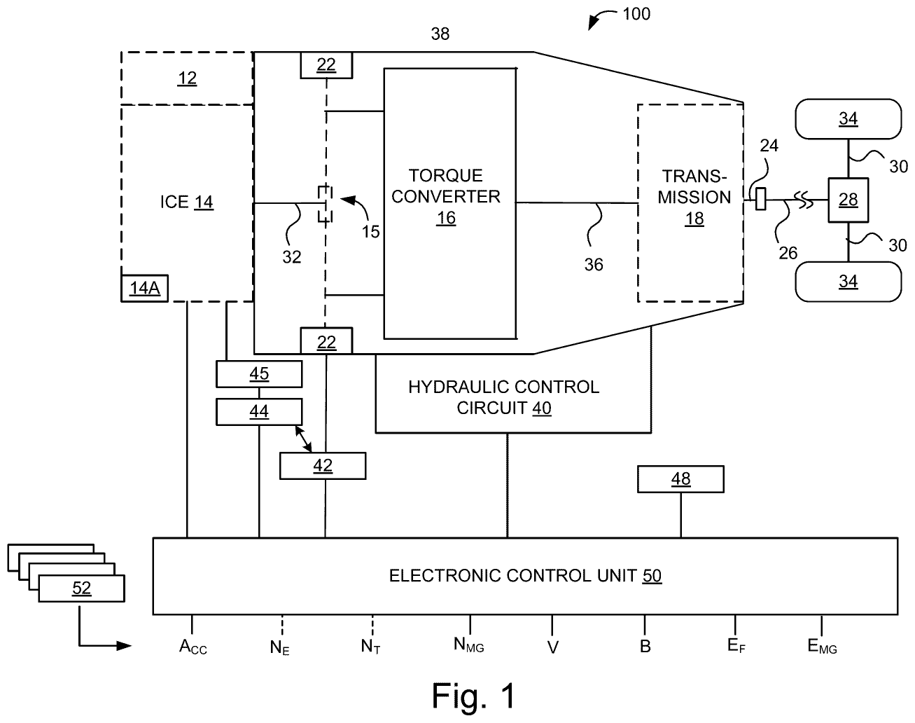

The systems and methods disclosed herein may be implemented with any of a number of different vehicles and vehicle types. For example, the systems and methods disclosed herein may be used with automobiles, trucks, motorcycles, recreational vehicles and other like on- or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for modeling sensor data as covariance for a SLAM system can be implemented in other types of vehicle including gasoline- or diesel-powered vehicles, fuel-cell vehicles, electric vehicles, or other vehicles.

FIG. 1 illustrates a drive system of vehicle 100 that may include an internal combustion engine 14 and one or more electric motors 22 (which may also serve as generators) as sources of motive power. Driving force generated by the internal combustion engine 14 and motors 22 can be transmitted to one or more wheels 34 via a torque converter 16, a transmission 18, a differential gear device 28, and a pair of axles 30.

As an HEV, vehicle 100 may be driven/powered with either or both of engine 14 and the motor(s) 22 as the drive source for travel. For example, a first travel mode may be an engine-only travel mode that only uses internal combustion engine 14 as the source of motive power. A second travel mode may be an EV travel mode that only uses the motor(s) 22 as the source of motive power. A third travel mode may be an HEV travel mode that uses engine 14 and the motor(s) 22 as the sources of motive power. In the engine-only and HEV travel modes, vehicle 100 relies on the motive force generated at least by internal combustion engine 14, and a clutch 15 may be included to engage engine 14. In the EV travel mode, vehicle 100 is powered by the motive force generated by motor 22 while engine 14 may be stopped and clutch 15 disengaged.

Engine 14 can be an internal combustion engine such as a gasoline, diesel or similarly powered engine in which fuel is injected into and combusted in a combustion chamber. A cooling system 12 can be provided to cool the engine 14 such as, for example, by removing excess heat from engine 14. For example, cooling system 12 can be implemented to include a radiator, a water pump and a series of cooling channels. In operation, the water pump circulates coolant through the engine 14 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 14. In other applications, either or both the water pump and the fan may be operated by electric current such as from battery 44.

An output control circuit 14A may be provided to control drive (output torque) of engine 14. Output control circuit 14A may include a throttle actuator to control an electronic throttle valve that controls fuel injection, an ignition device that controls ignition timing, and the like. Output control circuit 14A may execute output control of engine 14 according to a command control signal(s) supplied from an electronic control unit 50, described below. Such output control can include, for example, throttle control, fuel injection control, and ignition timing control.

Motor 22 can also be used to provide motive power in vehicle 100 and is powered electrically via a battery 44. Battery 44 may be implemented as one or more batteries or other power storage devices including, for example, lead-acid batteries, nickel-metal hydride batteries, lithium ion batteries, capacitive storage devices, and so on. Battery 44 may be charged by a battery charger 45 that receives energy from internal combustion engine 14. For example, an alternator or generator may be coupled directly or indirectly to a drive shaft of internal combustion engine 14 to generate an electrical current as a result of the operation of internal combustion engine 14. A clutch can be included to engage/disengage the battery charger 45. Battery 44 may also be charged by motor 22 such as, for example, by regenerative braking or by coasting during which time motor 22 operate as generator.

Motor 22 can be powered by battery 44 to generate a motive force to move the vehicle and adjust vehicle speed. Motor 22 can also function as a generator to generate electrical power such as, for example, when coasting or braking. Battery 44 may also be used to power other electrical or electronic systems in the vehicle. Motor 22 may be connected to battery 44 via an inverter 42. Battery 44 can include, for example, one or more batteries, capacitive storage units, or other storage reservoirs suitable for storing electrical energy that can be used to power motor 22. When battery 44 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 50 (described below) may be included and may control the electric drive components of the vehicle as well as other vehicle components. For example, electronic control unit 50 may control inverter 42, adjust driving current supplied to motor 22, and adjust the current received from motor 22 during regenerative coasting and breaking. As a more particular example, output torque of the motor 22 can be increased or decreased by electronic control unit 50 through the inverter 42.

A torque converter 16 can be included to control the application of power from engine 14 and motor 22 to transmission 18. Torque converter 16 can include a viscous fluid coupling that transfers rotational power from the motive power source to the driveshaft via the transmission. Torque converter 16 can include a conventional torque converter or a lockup torque converter. In other embodiments, a mechanical clutch can be used in place of torque converter 16.

Clutch 15 can be included to engage and disengage engine 14 from the drivetrain of the vehicle. In the illustrated example, a crankshaft 32, which is an output member of engine 14, may be selectively coupled to the motor 22 and torque converter 16 via clutch 15. Clutch 15 can be implemented as, for example, a multiple disc type hydraulic frictional engagement device whose engagement is controlled by an actuator such as a hydraulic actuator. Clutch 15 may be controlled such that its engagement state is complete engagement, slip engagement, and complete disengagement complete disengagement, depending on the pressure applied to the clutch. For example, a torque capacity of clutch 15 may be controlled according to the hydraulic pressure supplied from a hydraulic control circuit (not illustrated). When clutch 15 is engaged, power transmission is provided in the power transmission path between the crankshaft 32 and torque converter 16. On the other hand, when clutch 15 is disengaged, motive power from engine 14 is not delivered to the torque converter 16. In a slip engagement state, clutch 15 is engaged, and motive power is provided to torque converter 16 according to a torque capacity (transmission torque) of the clutch 15.

As alluded to above, vehicle 100 may include an electronic control unit 50. Electronic control unit 50 may include circuitry to control various aspects of the vehicle operation. Electronic control unit 50 may include, for example, a microcomputer that includes a one or more processing units (e.g., microprocessors), memory storage (e.g., RAM, ROM, etc.), and I/O devices. The processing units of electronic control unit 50, execute instructions stored in memory to control one or more electrical systems or subsystems in the vehicle. Electronic control unit 50 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 50 receives information from a plurality of sensors included in vehicle 100. For example, electronic control unit 50 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 14 (engine RPM), a rotational speed, NMG, of the motor 22 (motor rotational speed), and vehicle speed, NV. These may also include torque converter 16 output, NT (e.g., output amps indicative of motor output), brake operation amount/pressure, B, battery SOC (i.e., the charged amount for battery 44 detected by an SOC sensor). Accordingly, vehicle 100 can include a plurality of sensors 52 that can be used to detect various conditions internal or external to the vehicle and provide sensed conditions to engine control unit 50 (which, again, may be implemented as one or a plurality of individual control circuits). In one embodiment, sensors 52 may be included to detect one or more conditions directly or indirectly such as, for example, fuel efficiency, EF, motor efficiency, EMG, hybrid (internal combustion engine 14+MG 12) efficiency, acceleration, ACC, etc.

In some embodiments, one or more of the sensors 52 may include their own processing capability to compute the results for additional information that can be provided to electronic control unit 50. In other embodiments, one or more sensors may be data-gathering-only sensors that provide only raw data to electronic control unit 50. In further embodiments, hybrid sensors may be included that provide a combination of raw data and processed data to electronic control unit 50. Sensors 52 may provide an analog output or a digital output.

Sensors 52 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect, for example, traffic signs indicating a current speed limit, road curvature, obstacles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

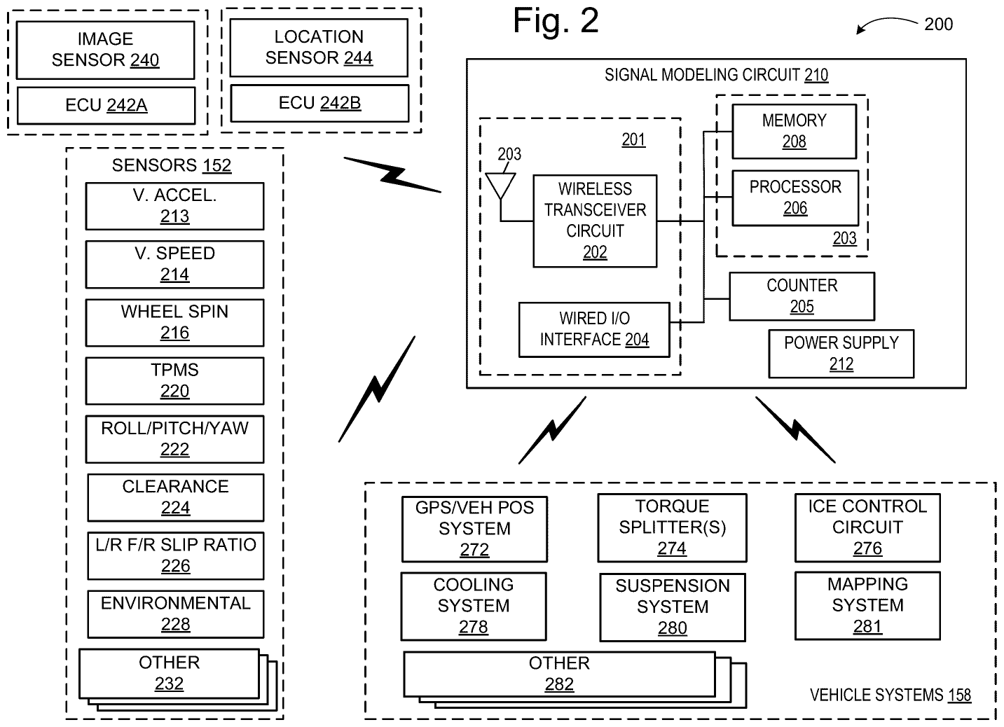

FIG. 2 illustrates an example architecture for location signal modeling using sensor data from self-contained sensors, in accordance with some embodiments of the systems and methods described herein. In example 200, the vehicle system illustrated can include signal modeling circuit 210, a plurality of sensors 152 and a plurality of vehicle systems 158. The sensors may comprise both self-contained sensors, illustrated as sensors that are coupled with their own control units, processors, or electronic control units (used interchangeably), and standard sensors that are coupled with other vehicle components and a shared electronic control unit. Illustrative examples of various types of sensors are provided in FIG. 2, including self-contained sensors that are illustrated as image sensor 240 with a corresponding electronic control unit 242A and location sensor 244 with a corresponding electronic control unit 242B.

Sensors 152 and vehicle systems 158 can communicate with signal modeling circuit 210 via a wired or wireless communication interface. Although sensors 152 and vehicle systems 158 are depicted as communicating with signal modeling circuit 210, they can also communicate with each other as well as with other vehicle systems. Signal modeling circuit 210 can be implemented as an electronic control unit or as part of an electronic control unit such as, for example electronic control unit 50. In other embodiments, signal modeling circuit 210 can be implemented independently of the electronic control unit.

Signal modeling circuit 210, in this example, includes a communication circuit 201, a decision circuit 203 (including a processor 206 and memory 208 in this example) and a power supply 212. Components of signal modeling circuit 210 are illustrated as communicating with each other via a data bus, although other communication in interfaces can be included. Signal modeling circuit 210, in this example, includes counter 205 that can be accessed by various vehicle systems to append a counter value to other sensor data. Counter 205 may comprise a digital clock or incremental value generator that can generate incremental values at a consistent rate (e.g., 1, 2, 3 at one second intervals).

Processor 206 can include one or more GPUs, CPUs, microprocessors, or any other suitable processing system. Processor 206 may include a single core or multicore processors. The memory 208 may include one or more various forms of memory or data storage (e.g., flash, RAM, etc.) that may be used to store the calibration parameters, images (analysis or historic), point parameters, instructions and variables for processor 206 as well as any other suitable information. Memory 208, can be made up of one or more modules of one or more different types of memory, and may be configured to store data and other information as well as operational instructions that may be used by the processor 206 to signal modeling circuit 210.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up signal modeling circuit 210.

Communication circuit 201 either or both a wireless transceiver circuit 202 with an associated antenna 203 and a wired I/O interface 204 with an associated hardwired data port (not illustrated). As this example illustrates, communications with signal modeling circuit 210 can include either or both wired and wireless communications circuits 201. Wireless transceiver circuit 202 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 203 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by signal modeling circuit 210 to/from other entities such as sensors 152 and vehicle systems 158.

Wired I/O interface 204 can include a transmitter and a receiver (not shown) for hardwired communications with other devices. For example, wired I/O interface 204 can provide a hardwired interface to other components, including sensors 152 and vehicle systems 158. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries), a power connector (e.g., to connect to vehicle supplied power, etc.), an energy harvester (e.g., solar cells, piezoelectric system, etc.), or it can include any other suitable power supply.

Sensors 152 can include, for example, sensors 52 such as those described above with reference to the example of FIG. 1. Sensors 152 can include additional sensors that may or may not otherwise be included on a standard vehicle 100 with which signal modeling circuit 210 is implemented. In the illustrated example, sensors 152 include vehicle acceleration sensors 213, vehicle speed sensors 214, wheelspin sensors 216 (e.g., one for each wheel), a tire pressure monitoring system (TPMS) 220, accelerometers such as a 3-axis accelerometer 222 to detect roll, pitch and yaw of the vehicle, vehicle clearance sensors 224, left-right and front-rear slip ratio sensors 226, and environmental sensors 228 (e.g., to detect salinity or other environmental conditions). Additional sensors 232 can also be included as may be appropriate for a given implementation of the system.

Vehicle systems 158 can include any of a number of different vehicle components or subsystems used to control or monitor various aspects of the vehicle and its performance. In this example, the vehicle systems 158 include a global navigation satellite system (GNSS), GPS, or other vehicle positioning system 272; torque splitters 274 that can control distribution of power among the vehicle wheels such as, for example, by controlling front/rear and left/right torque split; engine control circuits 276 to control the operation of engine (e.g. Internal combustion engine 14); cooling systems 278 to provide cooling for the motors, power electronics, the engine, or other vehicle systems; suspension system 280 such as, for example, an adjustable-height air suspension system, or an adjustable-damping suspension system; mapping system 281 such as a SLAM system; and other vehicle systems 282. In some examples, mapping system 281 may receive communications from an offline/external SLAM system that is implemented outside of the vehicle. The communications from mapping system 281 that are transmitted to the external SLAM system may comprise sensor data and mapping system 281 may receive the updated map from the external SLAM system.

During operation, signal modeling circuit 210 can receive information from various vehicle sensors. Communication circuit 201 can be used to transmit and receive information between signal modeling circuit 210 and sensors 152, and signal modeling circuit 210 and vehicle systems 158. Also, sensors 152 may communicate with vehicle systems 158 directly or indirectly (e.g., via communication circuit 201 or otherwise).

In some examples, signal modeling circuit 210 can receive information from various vehicle sensors and append a counter value that is generated by counter 205. In some examples, counter 205 is an incremental value generator that can generate incremental values at a consistent rate (e.g., 1, 2, 3 at one second intervals). In some examples, counter 205 is a digital clock that generates a timestamp in accordance with a digital clock. Signal modeling circuit 210 may append various counter values, including hardware timestamps that indicate the exact time at which each measurement was taken, or software timestamps that estimate the time offset between sensors. In some examples, the counter value is a measurement of the time delay between sensor readings. In some examples, the counter value is an incremental value irrespective of a timestamp.

Counter 205 is configured to incrementally generate the counter values that can be appended to sensor data. In some examples, the counter values may create time-series data of the location data and the image data that can be monitored over a period of time.

In some examples, the counter values may be implemented to help maintain a temporal consistency in sensor data for increased accuracy in motion estimation and mapping. The counter/time synchronization can coordinate/align sensor data, such as location data with image data based on the counter values associated with each. Other counter values may be incrementally synchronized as well, including odometry from wheel encoders and IMU measurements, with the location, orientation, and speed of the vehicle.

In various embodiments, communication circuit 201 can be configured to receive data and other information from sensors 152 that is used in generate sensor-based modeling of landmarks in an environment of the vehicle. The sensors may comprise both self-contained sensors (e.g., sensors that are communicatively coupled with their own electronic control units) and standard sensors (e.g., sensors that are communicatively coupled with other vehicle components and a shared electronic control unit). Illustrative examples of self-contained sensors are image sensor 240 and image electronic control unit 242A and location sensor 244 and location electronic control unit 242B. Illustrative examples of standard sensors that are coupled with other vehicle components and a shared electronic control unit are acceleration sensors 213, vehicle speed sensors 214, wheelspin sensors 216, tire pressure monitoring system (TPMS) 220, accelerometers 222, vehicle clearance sensors 224, slip ratio sensors 226, and environmental sensors 228.

Image sensor 240 is configured to generate image data of the environment surrounding the vehicle. Image sensor 240 may comprise a camera. The image data may comprise images of the visual environment surrounding the vehicle.

Location sensor 244 is configured to generate location data of landmarks in the environment surrounding the vehicle or location data of the vehicle itself. Location sensor 244 may comprise a Global Positioning System (GPS) sensor in communication with GPS satellites to receive geographic location information. The location data may comprise precise coordinates (e.g., latitude, longitude, and altitude) of the vehicle's current position on the Earth's surface.

Image sensor 240 may be coupled with image electronic control unit 242A and location sensor 244 may be coupled with location electronic control unit 242B. Other electronic control units may be implemented at vehicle 100 to control various vehicle systems. In some examples, electronic control unit 242 may control image sensor 240 and location sensor 244 (e.g., to generate location/image data, to transmit data to mapping system 281, etc.).

Mapping system 281 may receive the image data from image sensor 240 and location data from location sensor 244 to determine a landmark in the environment. In some examples, mapping system 281 may model a SLAM system that builds a map and localizes a vehicle in the map. The system may build the map and localize the vehicle simultaneously. Mapping system 281 can allow the vehicle to map out unknown environments and carry out tasks such as path planning and obstacle avoidance.

Mapping system 281 may generate a covariance of the location of the landmark using an ellipsoid in the mapping process. The covariance may be the uncertainty associated with the estimated location of the landmarks in the environment. Mapping system 281 may generate a covariance matrix to represent the uncertainty of the location of the landmark. In some examples, the location of the landmark may be based on data generated by the location sensor and image sensor. The covariance of the location of the landmark may be represented by the ellipsoid, where the covariance measures sensor noise and errors in motion (e.g., while the vehicle is in motion). The covariance matrix can quantify the uncertainty by describing the spread or dispersion of estimated quantities throughout the ellipsoid.

To rely on both the location sensor and the image sensor, mapping system 281 may synchronize image data and location data based on the counter values associated with each data source. The synchronization of the counter values can help ensure that sensor data from different sources are aligned at the time the sensor data was generated. This alignment can help mapping system 281 fuse data from multiple sensors, such as cameras, LIDARs, and IMUs (Inertial Measurement Units), to estimate the vehicle's position and map the environment accurately.

In some examples, mapping system 281 may determine a synchronization error. For example, an error in the location data may be represented as a random variable. Mapping system 281 may propagate a timestamp error to a location position error, and consequently to the posterior covariance of the poses. Mapping system 281 may also propagate 1) the posterior pose covariance and 2) the landmark observation covariance to determine the ellipsoid representing the location of the landmark.

In some examples, the posterior associated with the ellipsoid (e.g., the location of the landmark) may be calculated using Bayes' theorem, which represents a probability distribution of the system state (e.g., location of the landmark) given the observed data. Bayes' theorem may combine the prior knowledge about the system state with the likelihood of observing the data given the current state. The posterior distribution may be denoted as p(x|z), where x is the system state and z is the observed data.

Mapping system 281 may determine a posterior covariance matrix, which represents the uncertainty or variability in the estimated system state after incorporating the observed sensor data. The posterior covariance matrix may quantify the covariance or correlation between different components of the state vector. In some examples, a larger covariance value associated with the system state can correspond with a higher uncertainty.

In mapping, the posterior and posterior covariance matrix may correspond with an ellipsoid that quantifies the uncertainty/covariance of the location of the landmark.

Mapping system 281 may update the posterior and posterior covariance recursively as new sensor data is available, e.g., using techniques such as the Extended Kalman Filter (EKF) or the Unscented Kalman Filter (UKF). The filters may propagate the system state (location of the landmark) and covariance forward in time or forward in the incremental counter value while incorporating new observations to refine the estimate and reduce uncertainty.

The ellipsoid may comprise a three-dimensional geometric shape that has three semi-axes of different lengths that represents an uncertain/covariance location of the landmark in an environment. These axes intersect at the center of the ellipsoid, and the lengths of the axes determine the shape of the ellipsoid. The ellipsoid may be defined as the set of all points in three-dimensional space where a, b, and c are the lengths of the semi-axes along the x, y, and z directions, respectively:

$$\frac{{x}^{2}}{{a}^{2}} + \frac{{y}^{2}}{{b}^{2}} + \frac{{z}^{2}}{{c}^{2}} = 1$$

The ellipsoid may be adjusted based on the speed of the vehicle. For example, the value Tau may represent the standard deviation of the time-sync error in seconds. The time-sync error can manifest itself along the direction of travel. At higher speeds, the effect of time-sync error grows. As an illustrative example, Tau may be set to 2 seconds, which implies that mapping system 281 may expect a time-sync between the camera and GPS to have an uncertainty/covariance of +−2 seconds. As the speed of the vehicle increases, the uncertainty/covariance may increase to +−3 seconds.

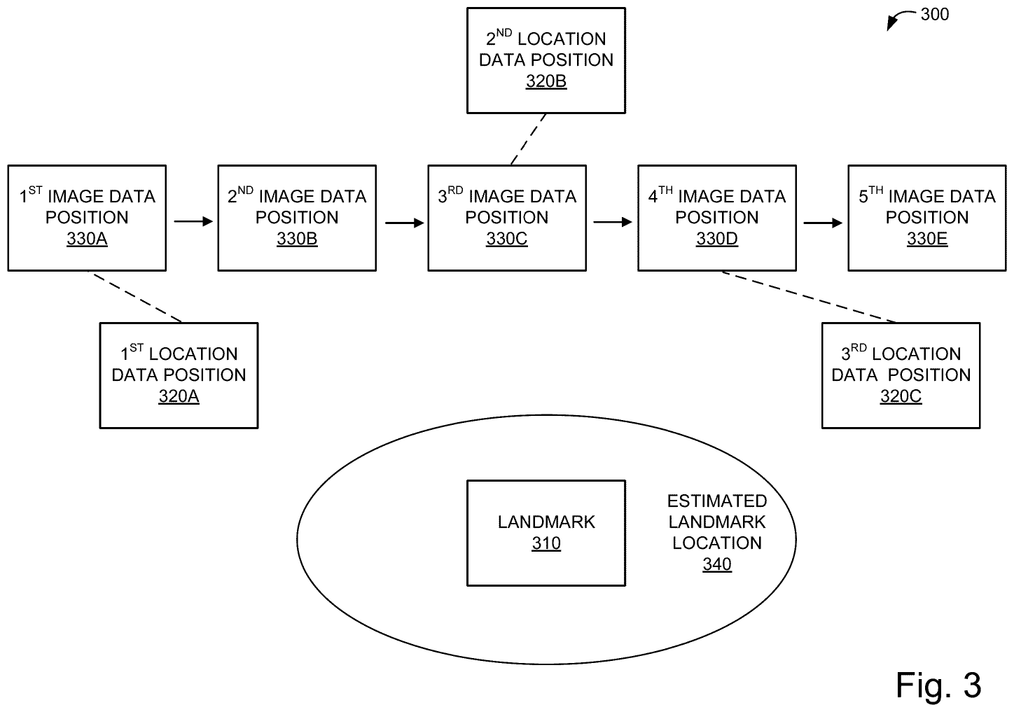

FIG. 3 illustrates sensor data for identifying a landmark, in accordance with some embodiments of the systems and methods described herein. In example 300, the vehicle may travel in an environment and simultaneously generate sensor data of landmark 310 at different locations around the environment. The sensor data may comprise location data 320 generated by a location sensor on the vehicle and image data 330 generated by an image sensor on the vehicle. As illustrated in example 300, the vehicle generates first image data 330A at a first location using the image sensor on the vehicle, and continues to move throughout the environment generating second image data 330B, third image data 330C, fourth image data 330D, and fifth image data 330E. Simultaneously, the vehicle may generate first location data 320A, and continues to throughout the environment generating second location data 320B and third location data 320C.

In some examples, the vehicle may append a counter value to the location data and the image data. For example, as the vehicle moves throughout the environment, the counter value creates an incremental correlation of the sensor data values to each other. For example, a lower counter value may correspond with sensor data that is generated by the vehicle at an earlier time than sensor data that is generated by the vehicle with a higher counter value. The counter values may be consistently generated by a counter associated with the vehicle and allow mapping systems to incrementally synchronize the location data and the image data using the counter values.

The mapping system of the vehicle may also generate the estimated landmark location 340 that identifies potential locations of landmark 310. For example, the vehicle may generate the posterior and posterior covariance matrix as an ellipsoid that quantifies the uncertainty/covariance of the location of the landmark 310 and is adjusted based on the speed of the vehicle as it moves about the landmark.

FIG. 4 illustrates a probabilistic data association process that account for timestamp errors in the data, in accordance with some embodiments of the systems and methods described herein. In example 400, a vehicle is traveling at a particular linear velocity 410 and angular velocity 420. The vehicle may generate image data while traveling at the particular linear velocity 410 and angular velocity 420, in order to generate first image data position 430A and a second image data position 430B.

Based on the vehicle's linear and angular velocity, as well as the generated data, the SLAM system may generate the ellipsoid that quantifies the speed of the vehicle. The determination may be based on, for example, a first-order projection of timestamp error variance in relation to the position of the vehicle when propagated through a constant velocity motion model.

In some examples, the timestamp error distribution is zero-mean and Gaussian (e.g., with variance σ²), which corresponds to equation:

$${Σ}_{timestamp \_ error} = F {σ}^{2} {F}^{T}$$

Where F is the Jacobian matrix/determinate of a constant linear velocity and constant angular velocity model with respect to time, donated as equation 440 in FIG. 4. The underlying location/GNSS position can be modeled as a propagation of the timestamp error into a constant velocity model of the vehicle.

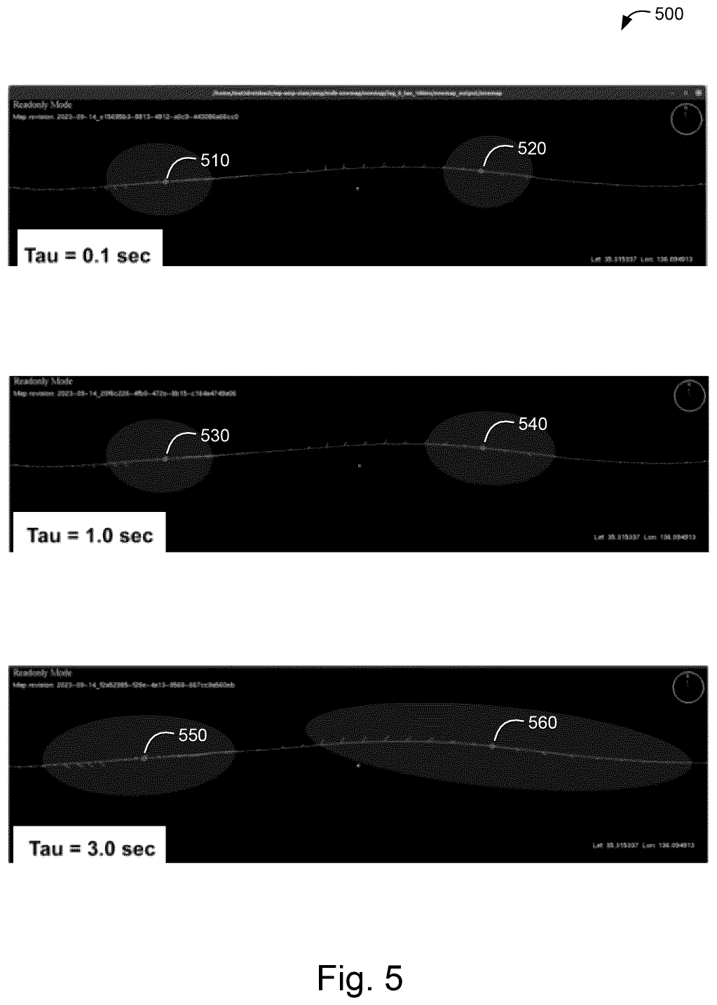

FIG. 5 shows examples of modeling the uncertainty in location covariance with respect to the speed of the vehicle, in accordance with some embodiments of the systems and methods described herein. In example 500, the posterior is calculated, for example, using Bayes' theorem and the posterior and posterior covariance recursively as new sensor data is available, e.g., using techniques such as the Extended Kalman Filter (EKF) or the Unscented Kalman Filter (UKF). Each ellipsoid illustrated in example 500 may illustrate a bird's eye view of the path of the vehicle moving throughout the environment.

The ellipsoid may be adjusted based on the speed of the vehicle. For example, the value Tau may represent the standard deviation of the synchronization error in seconds. The synchronization error can manifest itself along the direction of travel. At higher speeds, the effect of synchronization error can increase/grow.

At ellipsoid 510 and ellipsoid 520, Tau is set to 0.1 seconds, which implies that the mapping system of the vehicle may expect a time-sync between the camera and GPS to have an uncertainty/covariance of +−0.1 seconds.

At ellipsoid 530 and 540, Tau is set to 1.0 second, which implies that the mapping system of the vehicle may expect a time-sync between the camera and GPS to have an uncertainty/covariance of +−1.0 second.

At ellipsoid 550 and 560, Tau is set to 3.0 second, which implies that the mapping system of the vehicle may expect a time-sync between the camera and GPS to have an uncertainty/covariance of +−3.0 second.

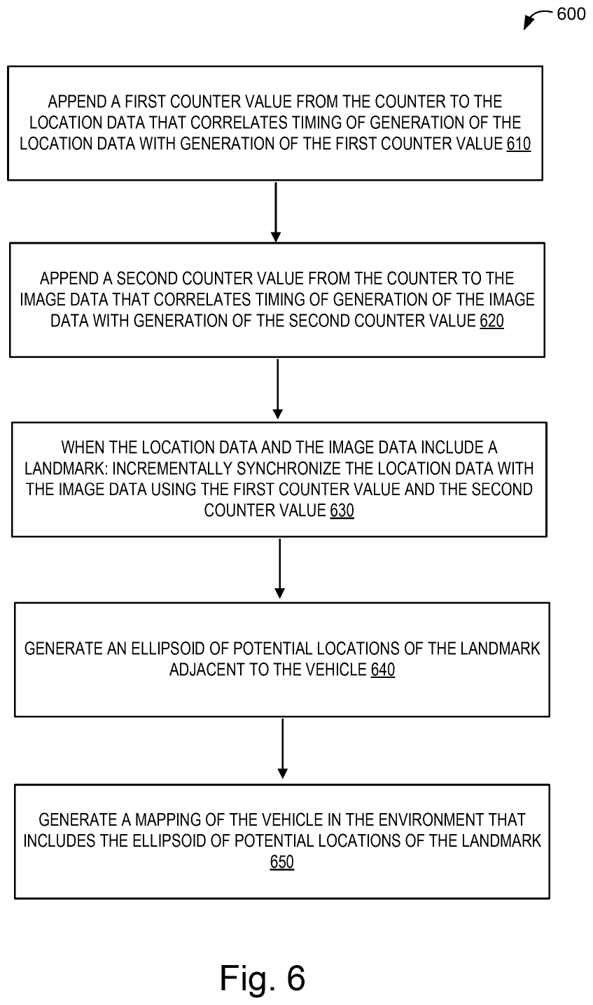

FIG. 6 illustrates a process for location signal modeling using sensor data from self-contained sensors, in accordance with some embodiments of the systems and methods described herein. In example 600, a vehicle in communication with a Simultaneous Localization and Mapping (SLAM) system may implement machine readable instructions to perform the process described herein. In some examples, the vehicle may comprise a location sensor coupled with a location control unit to generate location data of the vehicle in an environment, an image sensor coupled with an image control unit to generate image data of the vehicle in the environment, a counter configured to incrementally generate counter values that couples the counter values with the location data and the image data, a memory, and a processor. The process may be configured to execute machine readable instructions stored in the memory for causing the processor to perform various processes.

At block 610, the processor may append a first counter value from the counter to the location data that correlates timing of generation of the location data with generation of the first counter value.

At block 620, the processor may append a second counter value from the counter to the image data that correlates timing of generation of the image data with generation of the second counter value.

At block 630, the processor may incrementally synchronize the location data with the image data using the first counter value and the second counter value when the location data and the image data include a landmark.

At block 640, the processor may generate an ellipsoid of potential locations of the landmark adjacent to the vehicle.

At block 650, the processor may generate a mapping of the vehicle in the environment that includes the ellipsoid of potential locations of the landmark.

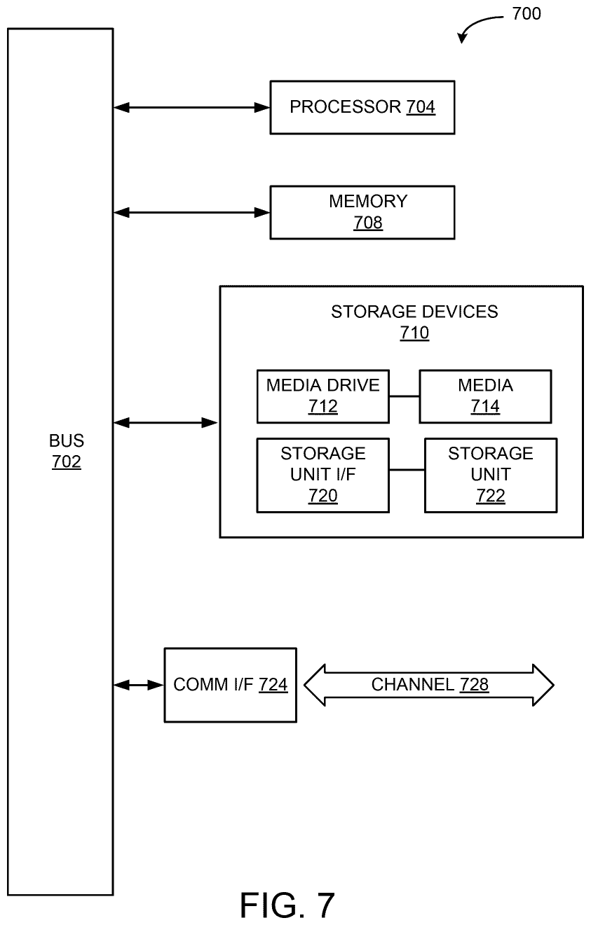

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 7. Various embodiments are described in terms of this example-computing component 700. After reading this description, it will become apparent to a person skilled in the relevant art how to implement the application using other computing components or architectures.

Referring now to FIG. 7, computing component 700 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 700 might also represent computing capabilities embedded within or otherwise available to a given device. For example, a computing component might be found in other electronic devices such as, for example, portable computing devices, and other electronic devices that might include some form of processing capability.

Computing component 700 might include, for example, one or more processors, controllers, control components, or other processing devices. Processor 704 might be implemented using a general-purpose or special-purpose processing engine such as, for example, a microprocessor, controller, or other control logic. Processor 704 may be connected to a bus 702. However, any communication medium can be used to facilitate interaction with other components of computing component 700 or to communicate externally.

Computing component 700 might also include one or more memory components, simply referred to herein as main memory 708. For example, random access memory (RAM) or other dynamic memory, might be used for storing information and instructions to be executed by processor 704. Main memory 708 might also be used for storing temporary variables or other intermediate information during execution of instructions to be executed by processor 704. Computing component 700 might likewise include a read only memory (“ROM”) or other static storage device coupled to bus 702 for storing static information and instructions for processor 704.

The computing component 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a solid-state drive, a magnetic tape drive, an optical drive, a compact disc (CD) or digital video disc (DVD) drive (R or RW), or other removable or fixed media drive might be provided. Storage media 714 might include, for example, a hard disk, an integrated circuit assembly, magnetic tape, cartridge, optical disk, a CD or DVD. Storage media 714 may be any other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing component 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory component) and memory slot. Other examples may include a PCMCIA slot and card, and other fixed or removable storage units 722 and interfaces 720 that allow software and data to be transferred from storage unit 722 to computing component 700.

Computing component 700 might also include a communications interface 724. Communications interface 724 might be used to allow software and data to be transferred between computing component 700 and external devices. Examples of communications interface 724 might include a modem or softmodem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 724 may be carried on signals, which can be electronic, electromagnetic (which includes optical) or other signals capable of being exchanged by a given communications interface 724. These signals might be provided to communications interface 724 via a channel 728. Channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 700 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A vehicle in communication with a Simultaneous Localization and Mapping (SLAM) system, the vehicle comprising:
a location sensor coupled with a location control unit to generate location data of the vehicle in an environment;
an image sensor coupled with an image control unit to generate image data of the vehicle in the environment;
a counter configured to incrementally generate counter values that couples the counter values with the location data and the image data;
a memory; and
a processor that us configured to execute machine readable instructions stored in the memory for causing the processor to:
append a first counter value from the counter to the location data that correlates timing of generation of the location data with generation of the first counter value;
append a second counter value from the counter to the image data that correlates timing of generation of the image data with generation of the second counter value;
when the location data and the image data include a landmark:
incrementally synchronize the location data with the image data using the first counter value and the second counter value;
generate an ellipsoid of potential locations of the landmark adjacent to the vehicle; and
generate a mapping of the vehicle in the environment that includes the ellipsoid of potential locations of the landmark.

2. The vehicle in communication with the SLAM system in claim 1, wherein the vehicle is in motion as the location data, the image data, and the counter values are being generated.

3. The vehicle in communication with the SLAM system in claim 1, wherein the ellipsoid is adjusted based on a speed of the vehicle through the environment.

4. The vehicle in communication with the SLAM system in claim 1, wherein the counter is configured to incrementally generate the counter values and creates time-series data of the location data and the image data monitored over a period of time.

5. The vehicle in communication with the SLAM system in claim 1, wherein the ellipsoid is calculated using Bayes' theorem.

6. The vehicle in communication with the SLAM system in claim 1, wherein posterior and posterior covariance of the ellipsoid is recursively determined as new sensor data is available using an Extended Kalman Filter (EKF) or an Unscented Kalman Filter (UKF).

7. The vehicle in communication with the SLAM system in claim 1, wherein the location data is incrementally synchronized with the image data by aligning the first counter value and the second counter value at a time the location data or the image data were generated to estimate a position of the vehicle.

8. A vehicle control system, comprising:
a processor; and
a memory coupled to the processor to store instructions, which when executed by the processor, cause the processor to perform operations, the operations comprising
append a first counter value to location data that correlates timing of generation of the location data with generation of the first counter value;
append a second counter value to image data that correlates timing of generation of the image data with generation of the second counter value;
when the location data and the image data include a landmark:
incrementally synchronize the location data with the image data using the first counter value and the second counter value;
generate an ellipsoid of potential locations of the landmark adjacent to a vehicle comprising the vehicle control system; and
generate a mapping of the vehicle in an environment that includes the ellipsoid of potential locations of the landmark.

9. The vehicle control system in claim 8, wherein the vehicle is in motion as the location data, image data, the first counter value, and the second counter value are being generated.

10. The vehicle control system in claim 8, wherein the ellipsoid is adjusted based on a speed of the vehicle through the environment.

11. The vehicle control system in claim 8, wherein a counter is configured to incrementally generate the first counter value and the second counter value and creates time-series data of the location data and the image data monitored over a period of time.

12. The vehicle control system in claim 8, wherein the ellipsoid is calculated using Bayes' theorem.

13. The vehicle control system in claim 8, wherein posterior and posterior covariance of the ellipsoid is recursively determined as new sensor data is available using an Extended Kalman Filter (EKF) or an Unscented Kalman Filter (UKF).

14. The vehicle control system in claim 8, wherein the location data is incrementally synchronized with the image data by aligning the first counter value and the second counter value at a time the location data or the image data was generated to estimate a position of the vehicle.

15. A non-transitory machine-readable medium having instructions stored therein, which when executed by a processor, cause the processor to perform operations, the operations comprising:
append a first counter value to location data that correlates timing of generation of the location data with generation of the first counter value;
append a second counter value to image data that correlates timing of generation of the image data with generation of the second counter value;
when the location data and the image data include a landmark:
incrementally synchronize the location data with the image data using the first counter value and the second counter value;
generate an ellipsoid of potential locations of the landmark adjacent to a vehicle; and
generate a mapping of the vehicle in an environment that includes the ellipsoid of potential locations of the landmark.

16. The non-transitory machine-readable medium in claim 15, wherein the vehicle is in motion as the location data, image data, the first counter value, and the second counter value are being generated.

17. The non-transitory machine-readable medium in claim 15, wherein the ellipsoid is adjusted based on a speed of the vehicle through the environment.

18. The non-transitory machine-readable medium in claim 15, wherein a counter is configured to incrementally generate the first counter value and the second counter value and creates time-series data of the location data and the image data monitored over a period of time.

19. The non-transitory machine-readable medium in claim 15, wherein the ellipsoid is calculated using Bayes' theorem.

20. The non-transitory machine-readable medium in claim 15, wherein posterior and posterior covariance of the ellipsoid is recursively determined as new sensor data is available using an Extended Kalman Filter (EKF) or an Unscented Kalman Filter (UKF).
